(19) United States
(12) Patent Application Publication
(10) Pub. No.: US 2011/0035765 A1
(43) Pub. Date: Feb. 10, 2011

(54) SYSTEMS AND METHODS FOR PROVIDING PROGRAMMING CONTENT

(75) Inventor: Amey Shirali, Goa (IN)

Correspondence Address: INGRASSIA FISHER & LORENZ, P.C. (EchoStar), 7010 E. COCHISE ROAD, SCOTTSDALE, AZ, 85253, US

(73) Assignee: SLING MEDIA PVT LTD, Bangalore (IN)

(21) Appl. No.: 12/538,676

(22) Filed: Aug. 10, 2009

(51) Int. Cl. H04H 60/33; G06F 13/00

(52) U.S. Cl. 725/9; 725/61; 725/133

(57) ABSTRACT

Methods and systems are provided for providing a program to a user. A first program is provided to a user. A characteristic of the first program is identified. A second program having the same characteristic as the first program is identified. An input is received from the user while the user is viewing the first program. Upon receiving the input, the second program is provided to the user.

### TECHNICAL FIELD

The present invention generally relates to media content, and more particularly relates to systems and methods for providing programming media content for users.

### BACKGROUND

Most television viewers now receive their television signals through a content aggregator such as a cable or satellite television provider. For subscribers to a direct broadcast satellite (DBS) service, for example, television programming is received via a broadcast that is sent via a satellite to an antenna that is generally located on the exterior of a home or other structure. Other customers receive television programming through a cable, wireless or other medium. Programming is typically received at a receiver such as a “set top box” (STB) that demodulates the received signals and that converts the demodulated content into a format that can be presented to the viewer on a television or other display.

The average television user is faced with hundreds, if not thousands of different choices for programming content on different channels today. The user typically selects programming content by traversing the same viewing path. The user typically identifies certain channels and certain lineups to obtain the user's selected programming content. However, such typical channel traversing of television channels this can be an inconvenience. In addition, a user may not find an optimal selection of programming content using such typical channel traversing.

Accordingly, it is desirable to provide an improved method for providing programming content for a user, for example that provides more convenience and/or a more optimal selection of programming content for the user. It is also desirable to provide an improved system for such providing of programming content for the user. Furthermore, other desirable features and characteristics of the present invention will be apparent from the subsequent detailed description and the appended claims, taken in conjunction with the accompanying drawings and the foregoing technical field and background.

### BRIEF SUMMARY

In accordance with an exemplary embodiment of the present invention, a method for providing a program to a user is provided. The method comprises the steps of providing a first program to a user, identifying a characteristic of the first program, identifying a second program having the same characteristic as the first program, receiving an input from the user while the user is viewing the first program, and, upon receiving the input, providing the second program to the user.

In accordance with another exemplary embodiment of the present invention, another method for providing a program to a user is provided. The method comprises the steps of identifying a characteristic of a plurality of programs watched by the user, identifying an additional program having the characteristic, receiving an input from the user while the user is watching one of the plurality of programs, and providing the additional program to the user substantially simultaneously upon receiving the input.

In accordance with a further exemplary embodiment of the present invention, a system for providing a program to a user is provided. The system comprises a display interface and a processor. The display interface is configured to provide programming to a user on a display. The user interface is configured to receive a request from the user while the user is watching a first program on the display. The processor is configured identify a characteristic of the first program, to identify a second program that is currently available having the characteristic, and to provide the second program for the user on the display in response to the request.

The system comprises an interface and a processor. The interface is configured to receive a request for programming content navigation from the user. The processor is coupled to perform the following steps when the request is received: identifying a characteristic of a first program watched by the user, identifying a second program having the characteristic, and providing the second program for the user.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary content providing system for providing programming content for a user, depicted along with a television and various content providers used in connection therewith, in accordance with an exemplary embodiment of the present invention; and

FIG. 2 is a flowchart of a process for providing programming content for a user, and that can be used in connection with the system block diagram of an exemplary content providing system of FIG. 1, in accordance with an exemplary embodiment of the present invention.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

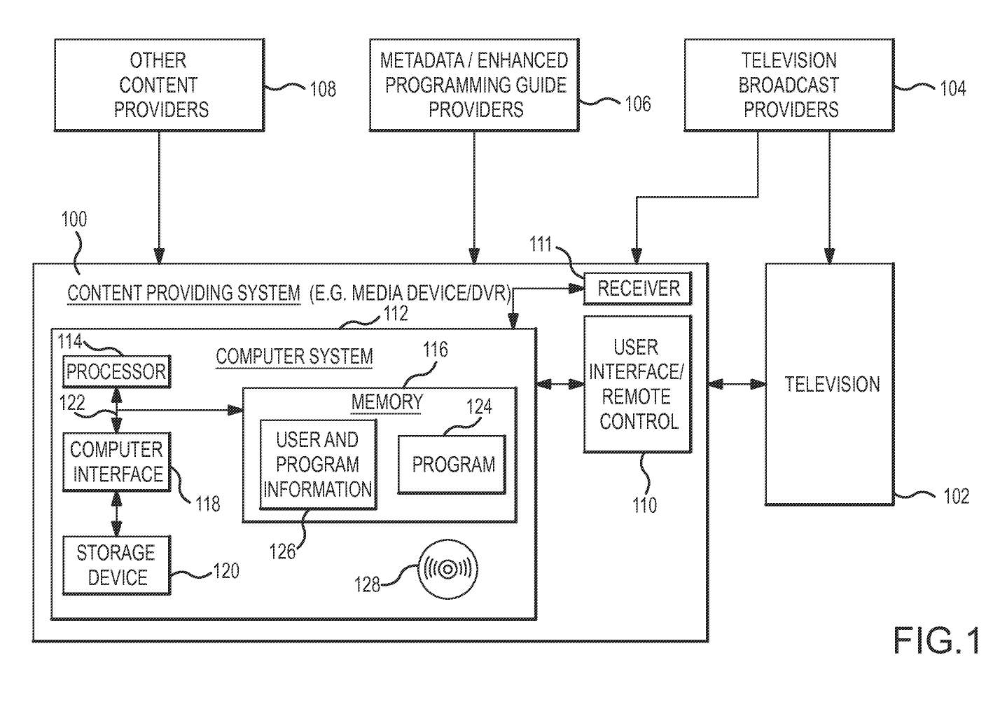

FIG. 1 is a block diagram of an exemplary content providing system 100 for providing programming content for a user, in accordance with an exemplary embodiment of the present invention. The content providing system 100 is depicted in FIG. 1 along with references to a television 102, one or more television broadcast providers 104, one or more metadata and/or enhanced programming guide providers 106, and one or more other content providers 108, also in accordance with an exemplary embodiment of the present invention.

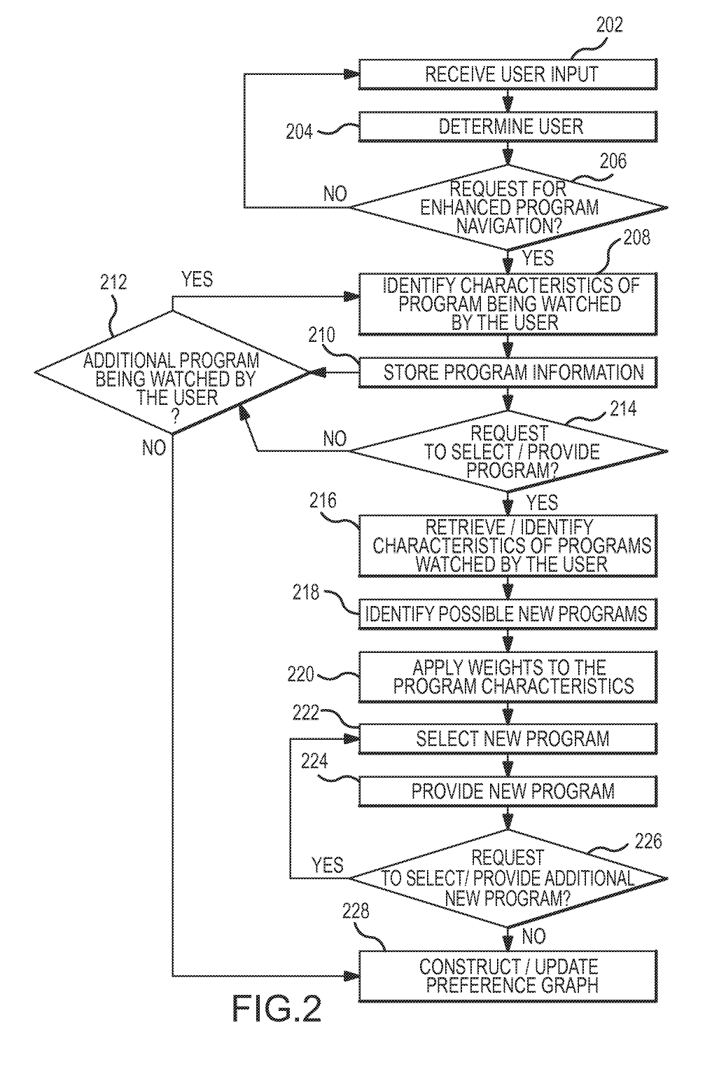

The content providing system 100 providers programming content for one or more users. In so doing, the content providing system 100 improves programming navigation for the users and provides more convenient and optimal programming content selection for the users. It will be appreciated that the content providing system 100 can be used in connection with any number of users in different embodiments. In a preferred embodiment, the content providing system 100 performs these functions in accordance with the steps of the process 200 of FIG. 2 and described further below in connection therewith. In a preferred embodiment, the content providing system 100 comprises a media device. For example, in one particular preferred embodiment, the content providing system 100 comprises a digital video recorder (DVR). However, this may vary in other embodiments.

In one preferred embodiment, the content providing system 100 is used in connection with one or more televisions 102 of the users. Specifically, in a preferred embodiment, programs displayed on the television 102 are monitored by the content providing system 100. In addition, also in a preferred embodiment, the programming content selected by the content providing system 100 is also provided on the television 102.

Also in one preferred embodiment, the content providing system 100 is used in connection with one or more television broadcast providers 104 that provide programming content to the television 102 and/or to the content providing system 100. In addition, in a preferred embodiment, the content providing system 100 is also used in connection with one or more metadata and/or enhanced programming guide (EPG) providers 106 that provide metadata and/or other information pertaining to the providing programming content (for example, metadata and/or other information pertaining to the programming content provided by the television broadcast providers 104) to the television 102 and/or to the content providing system 100.

In other embodiments, the content providing system 100 is used in connection with programs that are provided on media other than a television 102. For example, in certain other embodiments, the content providing system 100 may monitor programs that are being watched by the user on other media, such as a computer, a video game console, a portable media device, and/or on or in connection with one or more other media devices. Also in certain of these other embodiments, the content providing system 100 may provide the selected programming content for the user on such other media, such as a computer, a video game console, a portable media device, and/or on or in connection with one or more other media devices. In addition, in certain of these other embodiments, the content providing system 100 may obtain programming content and/or metadata and/or other information pertaining thereto from one or more other sources that provide such programming content and/or metadata and/or other information pertaining thereto for such types of media devices.

In the depicted embodiment, the content providing system 100 includes a user interface 110, a receiver 111, and a computer system 112. The user interface 110 is configured to receive one or more requests for programming content navigation from the user. In one preferred embodiment, the user interface 110 comprises a remote control device. In another preferred embodiment, the user interface 110 comprises a touch screen control device. It will be appreciated that the user interface 110 may comprise a number of other different types of devices and/or systems.

In a preferred embodiment, the user interface 110 receives one or more requests as to whether the user wishes to have monitoring performed on the programs being watched by the user, for subsequent use in selecting programming content in the future. For example, in one such embodiment, the user may press a program monitoring off/on switch to indicate whether the user desires such programming monitoring to be conducted by the content providing system 100 for enhanced programming navigation. Also in a preferred embodiment, the user interface 110 also receives one or more additional requests for programming content selection when the user seeks assistance in programming content navigation. For example, in one such embodiment, the user may press a program select button when the user desires the content providing system 100 to select and provide programming content for the user.

The receiver 111 is configured to receive metadata or other information regarding a program that is currently being watched by the user. In a preferred embodiment, the metadata or other information pertains to one or more characteristics of the program, including one or more of the following: a title of the program, a genre of the program, and/or a subject matter of the program. In addition, in a preferred embodiment, the receiver 111 also receives similar metadata or other information pertaining to any number of other different programming content under consideration for selection for being provided for the user during the programming content navigation. In a preferred embodiment, the metadata or other information regarding the program being watched by the user and/or the programming content under consideration are obtained from one or more metadata and/or enhanced programming guide providers 106. In certain embodiments, such metadata and/or other information may be obtained from one or more television broadcast providers 104 and/or from one or more other content providers 108 (such as Internet content providers, by way of example only). Also in a preferred embodiment, the program being watched by the user and other programming content may also be obtained using the receiver 111, for example from one or more television broadcast providers 104 and/or one or more other content providers 108 (such as Internet content providers, by way of example only).

The computer system 112 is coupled to the user interface 110, the receiver 111, and the television 102. The computer system 112 is configured to select and provide programming content for the user when requested to do so by the user via the user interface 110. The computer system 112 selects and provides various programs of the programming content based upon one or more characteristics of programs that are currently being watched and/or that have been watched by the user, preferably determined based on the metadata or other information obtained by the receiver 111 and/or as obtained via one or more other devices. In a preferred embodiment, the computer system 112 performs these functions by implementing various steps of the process 200 of FIG. 2 and described further below in connection therewith.

In the depicted embodiment, the computer system 112 includes a processor 114, a memory 116, a computer interface 118, a storage device 120, and a bus 122. The processor 114 performs the computation and control functions of the computer system 112 and the content providing system 100, and may comprise any type of processor or multiple processors, single integrated circuits such as a microprocessor, or any suitable number of integrated circuit devices and/or circuit boards working in cooperation to accomplish the functions of a processing unit. During operation, the processor 114 executes one or more programs 124 contained within the memory 116 and, as such, controls the general operation of the content providing system 100 and the computer system 112. In a preferred embodiment, the processor 114 is coupled to the user interface 110, the receiver 111, and the television 102. Also in a preferred embodiment, the processor 114 performs the above-referenced functions by implementing various steps of the process 200 of FIG. 2 and described further below in connection therewith.

The memory 116 can be any type of suitable memory. This would include the various types of dynamic random access memory (DRAM) such as SDRAM, the various types of static RAM (SRAM), and the various types of non-volatile memory (PROM, EPROM, and flash). The bus 122 serves to transmit programs, data, status and other information or signals between the various components of the computer system 112. In a preferred embodiment, the memory 116 stores the above-referenced program 124.

The computer interface 118 allows communication to the computer system 112, for example from a system driver and/or another computer system, and can be implemented using any suitable method and apparatus. It can include one or more network interfaces to communicate with other systems or components. The computer interface 118 may also include one or more network interfaces to communicate with technicians, one or more storage interfaces to connect to storage apparatuses, such as the storage device 120, and/or one or interfaces with and/or comprising all or a portion of the user interface 110. Also in a preferred embodiment, the computer interface 118 comprises a display interface configured to provide programming to a user on a display, such as the television 102, based upon instructions provided by the processor 114 and in accordance with one or more processes such as the process 200 of FIG. 2.

The storage device 120 can be any suitable type of storage apparatus, including direct access storage devices such as hard disk drives, flash systems, floppy disk drives and optical disk drives. In one exemplary embodiment, the storage device 120 comprises a program product from which memory 116 can receive a program 124 that executes one or more embodiments of one or more processes of the present invention, such as the process 200 of FIG. 2 or portions thereof In another exemplary embodiment, the program product may be directly stored in and/or otherwise accessed by the memory 116 and/or a disk 128 such as that referenced below.

The bus 122 can be any suitable physical or logical means of connecting computer systems and components. This includes, but is not limited to, direct hard-wired connections, fiber optics, infrared and wireless bus technologies. During operation, the program 124 is stored in the memory 116 and executed by the processor 114.

It will be appreciated that while this exemplary embodiment is described in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks (e.g. disk 128), hard drives, memory cards and optical disks, and transmission media such as digital and analog communication links. It will similarly be appreciated that the computer system 112 may also otherwise differ from the embodiment depicted in FIG. 1, for example in that the computer system 112 may be coupled to or may otherwise utilize one or more remote computer systems and/or other control systems.

FIG. 2 is a flowchart of a process 200 for providing programming content for a user, in accordance with an exemplary embodiment of the present invention. In a preferred embodiment, the process 200 can be implemented and used in connection with the content providing system 100 of FIG. 1 and/or program products utilized therewith, in accordance with an exemplary embodiment of the present invention.

As depicted in FIG. 2, the process 200 begins with the step of receiving user input (step 202). In a preferred embodiment, the user input comprises information regarding the user, and is obtained via the user interface 110 of FIG. 1 and provided to the processor 114 of the content providing system 100 of FIG. 1 for processing.

Also in a preferred embodiment, the user input also comprises a request, if any, for enhanced programming content navigation, such as monitoring and tracking of programming content being watched by the user for subsequent use in selecting programming content for the user in the future. For example, in a preferred embodiment, the user may utilize the user interface 110 of FIG. 1, such as by engaging a program monitoring on/off switch of the user interface 110 of FIG. 1, to indicate when the user wishes for the content providing system 100 of FIG. 1 to conduct such enhanced programming content navigation. This information is then preferably provided by the user interface 110 of FIG. 1 to the processor 114 of FIG. 1 for processing.

In addition, in a preferred embodiment, the user input also comprises user requests, if any, for the selection and providing of additional programming content for the user. For example, in a preferred embodiment, the user may utilize the user interface 110, such as by engaging a program select button of the user interface 110 of FIG. 1, when the user wishes for the content providing system 100 of FIG. 1 to select and provide an additional program for the user to watch. This information is then preferably provided by the user interface 110 of FIG. 1 to the processor 114 of FIG. 1 for processing.

The identity of the user is determined based on the user input (step 204). Specifically, in a preferred embodiment, the processor 114 of the content providing system 100 of FIG. 1 identifies one or more users that are currently watching the television 102 of FIG. 1 based on the user input obtained during step 202.

A determination is then made as to whether the user has provided a request for enhanced program navigation (step 206). In a preferred embodiment, this determination comprises a determination as to whether the user has engaged an on/off switch or provided some other indication that the user desires the content providing system 100 of FIG. 1 to conduct monitoring and tracking of programming content being watched by the user for subsequent use in selecting programming content for the user in the future. Also in a preferred embodiment, this determination is made by the processor 114 of the content providing system 100 of FIG. 1 using the user input received in step 202.

If it is determined in step 206 that the user has not provided a request for enhanced program navigation, then the process returns to step 202, and additional user input is received. Steps 202-206 then repeat until there is a determination in an iteration of step 206 that the user has provided a request for enhanced program navigation.

Once a determination is made in an iteration of step 206 that the user has provided a request for enhanced program navigation, one or more characteristics are identified of a program being watched by the user (step 208). In a preferred embodiment, the program is provided on a display, such as the television 102 of FIG. 1. Also in a preferred embodiment, during step 208 metadata is obtained regarding the program being watched by the user, and the characteristics of the program are identified in step 208 using the metadata. In such preferred embodiment, the metadata is received by the receiver 111 of FIG. 1 from one or more of the metadata and/or enhanced programming guide provides 106 of FIG. 1 and provided to the processor 114 of FIG. 1. The processor 114 of FIG. 1 then uses the metadata in identifying the characteristics of the program.

Also in a preferred embodiment, during step 208 the processor 114 of the content providing system 100 of FIG. 1 identifies multiple characteristics of a program that is currently being watched by the user on the television 102 of FIG. 1. Also in a preferred embodiment, the characteristics include a title of the program being watched by the user, a genre of the program being watched by the user, and/or a subject matter of the program being watched by the user, among other possible characteristics of the program that is currently being watched by the user. In addition, in a preferred embodiment, the program characteristics are determined by the processor 114 of FIG. based on information (such as metadata and/or other information pertaining to the program) received by the receiver 111 of FIG. 1 from one or more of the television broadcast providers 104, the metadata and/or enhanced programming guide providers 106, and/or other content providers 108 of FIG. 1.

Information pertaining to the characteristics of the program identified in step 208 is stored for future use (step 210). In a preferred embodiment, this program information is stored in the memory 116 of the content providing system 100 of FIG. 1.

A determination is then made as to whether an additional program is now being watched by the user (step 212). For example, in accordance with an exemplary embodiment, when the user switches to a new channel on the television 102 of FIG. 1 with a new program, or when a new program begins on an current channel being watched on the television 102 of FIG. 1, a determination is made as to the additional program now being watched by the user on the television 102 of FIG. 1. In a preferred embodiment, this determination is made by the processor 114 of the content providing system 100 of FIG. 1. Also in a preferred embodiment, the additional programs are provided on a display, such as the television 102 of FIG. 1.

If it is determined in step 212 that an additional program is now being watched by the user, then the process returns to step 208, the characteristics of the additional program are identified in step 208, and information pertaining thereto is stored in step 210. Steps 208-212 thus repeat in various iterations until a determination is made in an iteration of step 212 that no programs are being watched by the user, at which point the process (in one exemplary embodiment) skips to step 228 described further below.

A determination is also made as to whether the user has provided a request to select and provide programming content for the user (step 214). In a preferred embodiment, the request is received, and this determination is made, while the user is watching one of the above-referenced programs of steps 208 and 214. Also in a preferred embodiment, this determination comprises a determination as to whether the user has engaged a program select button on the user interface 110 of FIG. 1 or provided some other indication that the user desires the content providing system 100 of FIG. 1 to select and provide one or more programs and/or programming content for the user. Also in a preferred embodiment, this determination is made by the processor 114 of the content providing system 100 of FIG. 1 using the user input received in step 202. Also in a preferred embodiment, this determination in step 214 is conducted continuously during and simultaneously with all iterations of steps 208-212 described above.

If it is determined in step 214 that the user has not provided a request to select and provide programming content for the user, then the process returns to step 212. Steps 210-214 repeat in various iterations until a determination is made in an iteration of step 214 that the user has provided a request to select and provide programming content for the user.

Once a determination is made in an iteration of step 214 that the user has provided a request to select and provide programming content for the user (for example, once the user engages a program select button on the user interface 110 of FIG. 1), various characteristics are retrieved and identified regarding the current program being watched by the user and various other programs that were previously watched by the user during an enhanced program navigation mode (step 216). In one preferred embodiment, these characteristics are retrieved from the memory 116 of the content providing system 100 of FIG. 1 and identified by the processor 114 of the content providing system 100 of FIG. 1. Also in a preferred embodiment, the characteristics are retrieved and identified based on the program characteristic identification in various iterations of step 208 and stored in step 210 while the user has requested enhanced program navigation. However, this may vary in other embodiments. For example, in certain embodiments, the characteristics may be retrieved and identified only for the current program being identified. In various other embodiments, the characteristics may be retrieved and identified for selected programs watched by the user over a predetermined period of time, such as a week or a month, among other possible variations.

Possible new programs are then identified (step 218). In a preferred embodiment, the possible new programs are identified from a large pool of possible programs available to the content providing system 100 from the television broadcast providers 104 of FIG. 1 (for example, that are currently being aired on a different television channel than that which is currently being watched on the television 102 of FIG. 1), from the other content providers 108 of FIG. 1 (for example, programming that may be available via the Internet, content providers thereof, and/or other content providers), from the memory 116 of the content providing system 100 of FIG. 1 (for example, that may be stored therein), and/'or from one or more other programming content sources.

Weights are then applied to the program characteristics identified in step 216 above (step 220). In a preferred embodiment, during step 220, the processor 114 of the content providing system 100 of FIG. 1 applies the weights to each of the program characteristics identified in step 216, to thereby generate weighted values for each of these programs that are currently being watched by the user and/or that have previously been watched by the user during an enhanced program navigation mode. In a preferred embodiment, the weights are also applied to the possible new programs identified in step 218.

The weights utilized in step 220 may vary in different embodiments. For example, in some embodiments, titles of the respective programs may be given relatively higher weight than other characteristics. As another example, in some other embodiments, genres of the respective programs may be given relatively higher weight than other characteristics. In yet other embodiments, various different characteristics may be given relatively higher weight as compared with other characteristics.

A new program is then selected based on the weighted values and the identified characteristics (step 222). In a preferred embodiment, the new program shares at least one identifying characteristic (such as a title, a genre, or a subject matter) with the program currently being watched by the user. In another embodiment, the new program shares at least one identifying characteristic (such as a title, a genre, or a subject matter) with another program that has recently been watched by the user. Also in a preferred embodiment, the new program is currently available while the user is watching the above-referenced program or additional programs of steps 208 and 212, so that the new program, if selected, can be provided for the user at least substantially simultaneously upon request to provide a nearly simultaneous channel surfing experience for the user.

In addition, in one preferred embodiment, the new program is selected in step 222 such that a set of characteristics or weighed values of the new program is as close as possible (based on a number of programs available for selection by the content providing system 100 of FIG. 1) to the characteristics or weighted values associated with the program that is currently being watched by the user and the programs that have previously been watched by the user during enhanced program navigation. In an alternate embodiment, the new program is selected in step 222 such that a set of characteristics or weighed values of the new program is as close as possible (based on a number of programs available for selection by the content providing system 100 of FIG. 1) to the characteristics or weighted values associated with only the current program being watched by the user.

The new program is then provided for the user (step 224). In a preferred embodiment, the processor 114 of FIG. 1 provides the new program for the user by displaying the new program on a display that the above-referenced programs are provided, most preferably on the television 102 of FIG. 1. In various other embodiments, the new program may be provided on one or more other different media devices, such as, by way of example only, a computer, a video game console, a portable media device, and/or one or more other different types of media devices. Also in a preferred embodiment, the new program is provided at least substantially simultaneously upon receipt of the request and/or the determination of step 214 pertaining thereto, to provide a nearly simultaneous channel surfing experience for the user.

A determination is then made as to whether the user has provided a request to have an additional new program selected and provided (step 226). If a determination is made in step 226 that the user has provided a request to have an additional new program selected and provided (for example, if the user presses the program select button again on the user interface 110 of FIG. 1), then steps 222-226 repeat, as an additional new program is selected (step 222) and provided (step 224) for the user, and the process continues to look for any new requests to provide additional new programs (step 226).

Following step 226, a preference graph is constructed and/or updated for the user (step 228). The preference graph represents a history of programming content watched by the user. The preference graph can be utilized in subsequent iterations of the process 200 (such as in steps 216-220 thereof) in identifying and selecting new content for the user when requested by the user.

In a preferred embodiment, the preference graph is constructed during a first iteration of step 228 and is updated during subsequent iterations of step 228. Also in a preferred embodiment, the preference graph is constructed and updated by the processor 114 of the computer system 112 of the content providing system 100 of FIG. 1, and is stored in the memory 116 thereof of FIG. 1. In addition, in a preferred embodiment, the process 200 continuously returns to step 226, as the process 200 and the content providing system 100 of FIG. 1 continually wait for any new instructions from the user to select and provide additional new programming content for the user.

In a preferred embodiment, the preference graph is constructed and cached over time each time that the user watches programming content on the television 102 of FIG. 1 and/or another media device. In a preferred embodiment, the user can instruct the content providing system 100 of FIG. 1 (for example, a digital video recorder) or other device to enable the device or a feature thereof to traverse the user's favorite programming as per the data mine built within. For example, if the user is viewing a first channel airing a first show and is now interested in viewing another show based on topics which are “similar”, the device and feature would jump correctly to the next channel or event grab an array of “similar” videos from the Internet (assuming network connectivity to the device). For example, new programming content with similar titles, subject matter, and/or genres of prior programming content watched by the user are thus selected and displayed for the user.

In one preferred embodiment, every channel-up is represented as a “program-hop”. This “program hop” can be mapped to a remote control button, such as the above-referenced program select button of the user interface 110 of FIG. 1. This can be used to jump the viewer to his “similar” content as the user hops from one program to another.

For example, in one preferred embodiment, the new programs that are selected and provided for the user have at least one of the identifying characteristics in common with a first program that is being watched or has been watched by the user. By way of further example, on a first “hop” the process 200 may select a second, new program with a similar title to the first program (for example, belonging to a series to which the first program also belongs). Similarly, on a second “hop” the process 200 may select a third, new program with a similar subject matter as the first program. As another example, on a third “hop” the process 200 may select a fourth, new program with a similar genre as the first program, and so on. By way of a further example for illustrative purposes only, a first “hop” may be used to select a second, new program with a similar subject matter as the first program, a second “hop” may be used to select a third, new program also with a similar subject matter as the first program, and so on. The various “hops” may follow any number of different paths in selecting and providing programming content for the user, in accordance with various different embodiments and implementations thereof.

An internal data-mine is preferably built and used in connection with the preference graph of step 228 for further processing, and that reflects the user's preferences for television watching. Every node in the constructed graph preferably has some weight associated with it. This weight could be a function of the frequency of viewing or the TAG associated with it which got triggered or any other recommendation attribute associated with the content. The user could additionally TAG or let the system know that he liked this show and that the system can cache the appropriate TAGS against it for “hopping”.

This smart-jumping content can be used to hyper-jump television content rather than rudimentary channel-up and channel-down or surfing for that matter. The user can be provided with the viewing experience that the user truly wants by detecting the viewing preferences automatically, thereby reducing or eliminating the need for “channel surfacing” by the user. Thus, in a preferred embodiment, the process 200 provides a solution that tracks (optionally if enabled by the user) the user's program viewing path.

As used herein, the word “exemplary” means “serving as an example, instance, or illustration.” Any implementation described herein as exemplary is not necessarily to be construed as preferred or advantageous over other implementations.

Accordingly, improved methods and systems are provided for providing programming content for users. The improved methods and systems provide for improved selection and providing of programming content for a user. The improved methods and systems provide enhanced program navigation for the user, for example by providing more convenience and/or a more optimal selection of programming content for the user.

It will be appreciated that the disclosed methods and systems may vary from those depicted in the Figures and described herein. For example, it will be appreciated that certain steps of the process 200 may vary from those depicted in FIG. 2 and/or described herein in connection therewith. It will similarly be appreciated that certain steps of the process 200 may occur simultaneously or in a different order than that depicted in FIG. 2 and/or described herein in connection therewith. It will also be appreciated that the content providing system 100 of FIG. 1, one or more components thereof, and/or one or more of the television 102 of FIG. 1, the television broadcast providers 104 of FIG. 1, the metadata and/or enhanced programming guide providers 106 of FIG. 1, and/or the other content providers 108 of FIG. 1 may also vary in different embodiments. It will similarly be appreciated that the disclosed methods and systems may be implemented and/or utilized in connection with any number of different types of media devices and/or other devices and/or systems in various embodiments.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A method comprising:
providing a first program to a user;
identifying a characteristic of the first program;
identifying a second program having the same characteristic as the first program;
receiving an input from the user while the user is viewing the first program; and
upon receiving the input, providing the second program to the user.

2. The method of claim 1, wherein the step of identifying the characteristic comprises the steps of:
obtaining metadata of the first program; and
identifying the characteristic using the metadata.

3. The method of claim 1, wherein the characteristic is selected from the group consisting of: a title of the first program, a genre of the first program, and a subject matter of the first program.

4. The method of claim 1, further comprising the steps of:
identifying a third program having the characteristic; and
providing the third program for the user.

5. The method of claim 1, further comprising the steps of:
identifying a second characteristic of the first program; and
identifying a third program having the characteristic; and
providing the third program for the user.

6. The method of claim 1, further comprising the steps of:
identifying a plurality of additional characteristics of the first program; and
applying a weight to the characteristic and the plurality of additional characteristics, to thereby generate a weighted value;
wherein the step of identifying the second program comprises the step of identifying the second program based at least in part on the weighted value.

7. The method of claim 1, wherein the step of providing the second program comprises the step of providing the second program if the input comprises a request for viewing an additional program.

8. The method of claim 7, wherein:
the step of identifying the characteristic comprises the step of identifying the characteristic of the first program if the input comprises a request to monitor programs viewed by the user.

9. A method comprising:
identifying a characteristic of a plurality of programs watched by the user;
identifying an additional program having the characteristic;
receiving an input from the user while the user is watching one of the plurality of programs; and
providing the additional program to the user substantially simultaneously upon receiving the input.

10. The method of claim 9, wherein the step of identifying the characteristic comprises the steps of:
obtaining metadata of the plurality of programs; and
identifying the characteristic using the metadata.

11. The method of claim 9, wherein the characteristic is selected from the group consisting of: a title of one or more of the plurality of programs, a genre of one or more of the plurality of programs, and a subject matter of one or more of the plurality of programs.

12. The method of claim 9, further comprising the steps of:
identifying an additional characteristic of the plurality of programs;
identifying a second additional program having the additional characteristic; and
providing the second additional program for the user.

13. The method of claim 9, further comprising the steps of:
identifying a plurality of additional characteristics of the plurality of programs; and
applying a weight to the characteristic and the plurality of additional characteristics, to thereby generate a weighted value;
wherein the step of identifying the additional program comprises the step of identifying the additional program using the weighted value.

14. The method of claim 9, further comprising the step of:
receiving an input from the user;
wherein the step of providing the additional program comprises the step of providing the additional program if the input comprises a request for viewing the additional program.

15. The method of claim 9, wherein the step of identifying the characteristic comprises the step of identifying the characteristic of the plurality of programs if the input comprises a request to monitor programs viewed by the user.

16. The method of claim 9, further comprising the step of:
identifying the user;
wherein each of the plurality of programs comprises a program that is being watched or has previously been watched by the user.

17. A system comprising:
a display interface configured to provide programming to a user on a display;
a user interface configured to receive a request from the user while the user is watching a first program on the display; and
a processor configured identify a characteristic of the first program, to identify a second program that is currently available having the characteristic, and to provide the second program to the user on the display in response to the request.

18. The system of claim 17, further comprising:
a receiver configured to obtain metadata of the first program, wherein the processor is coupled to the receiver and is further configured to identify the characteristic using the metadata.

19. The system of claim 17, wherein the processor is further configured to:
identify a third program having the characteristic; and
provide the third program for the user.

20. The system of claim 17, wherein the interface, the processor, or both, are part of a digital video recorder for a television.
